(19) United States
(12) Patent Application Publication
(10) Pub. No.: US 2009/0261613 A1
(43) Pub. Date: Oct. 22, 2009

(54) TRIM COMPONENT WITH RETENTION TABS

(75) Inventors: Galen W. Johnson, Chesterfield, MI (US); John F. Peck, JR., Canton, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 12/393,322

(22) Filed: Feb. 26, 2009

Related U.S. Application Data
(60) Provisional application No. 61/045,463, filed on Apr. 16, 2008.

(51) Int. Cl. B62D 25/14

(52) U.S. Cl. 296/72; 296/70

(57) ABSTRACT

A trim component such as a bezel for attachment to a trim panel, such as an instrument panel of a vehicle, is disclosed and includes one or more retention tabs for securing the trim component to the trim panel. The retention tabs provide for a plurality of limiting features that help in preventing a non-blunt contactable edge condition from occurring, particularly during an impact between the vehicle and another vehicle or object.

### CROSS-REFERENCE TO RELATED APPLICATIONS

This application claims the benefit of U.S. Provisional Application No. 61/045,463, filed Apr. 16, 2008.

### TECHNICAL FIELD

The following relates to a trim component for attachment to a trim panel, and more particularly to a bezel having integrally molded retention tabs for insertion into slots of an instrument panel substrate.

A detailed description and accompanying drawings are set forth below.

### BRIEF DESCRIPTION OF THE DRAWINGS

FIG. 1 is a simplified, exemplary environmental diagram depicting one embodiment of a trim component described herein;

FIG. 2 is a simplified, exemplary side view depicting one embodiment of a trim component described herein;

FIG. 3a is a simplified, exemplary perspective view depicting one embodiment of a retention tab described herein;

FIG. 3b is a simplified, exemplary perspective view depicting another embodiment of a retention tab described herein;

FIG. 4 is a simplified, exemplary side view depicting one embodiment of a retention tab described herein;

FIG. 5 is a simplified, exemplary top plan view depicting one embodiment of a retention tab described herein; and

FIGS. 6a-b are simplified, exemplary cross-sections depicting embodiments of the trim component attached to a trim panel described herein.

### DETAILED DESCRIPTION

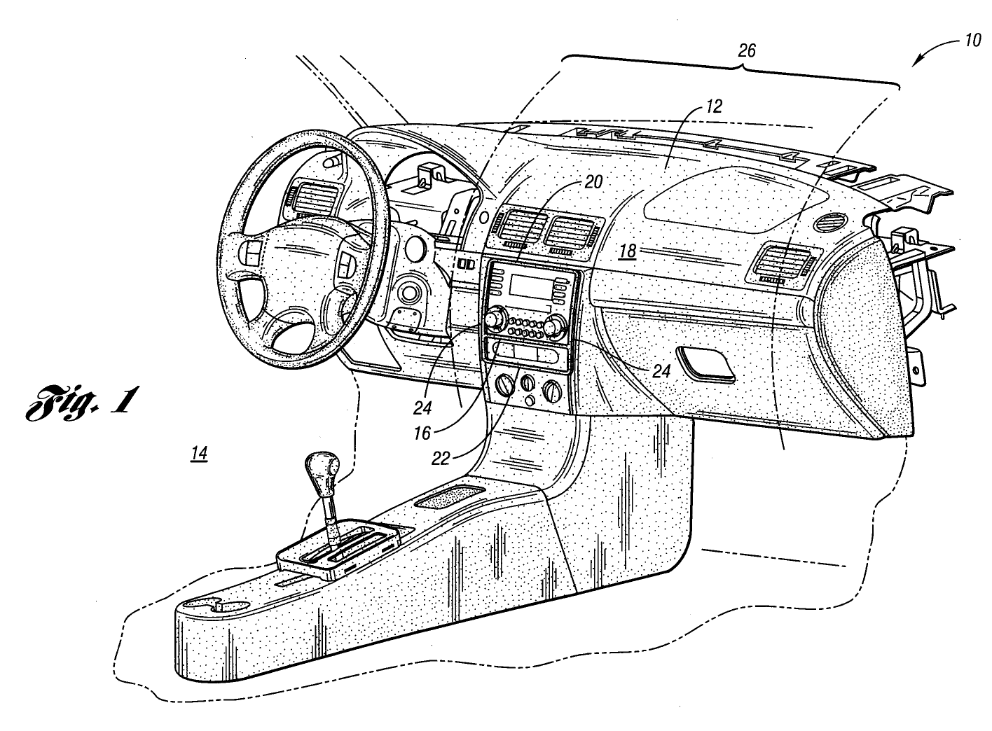

With reference to FIGS. 1-6, a more detailed description of embodiments of the bezel and various components thereof will now be provided. It is well known in the automotive industry that stringent safety guidelines exist to safeguard vehicle occupants and minimize dangerous vehicle-related incidents. One of the foremost regulatory authorities in the automotive industry is the National Highway Transportation Safety Administration (NHTSA). NHTSA is an agency of the Executive Branch of the U.S. Government, part of the Department of Transportation. It describes its mission as “Save lives, prevent injuries, reduce vehicle-related crashes.”

As part of its activities, NHTSA is charged with writing and enforcing safety, theft-resistance, and fuel economy standards for motor vehicles. NHTSA also licenses vehicle manufacturers and importers, allows or blocks the import of vehicles and safety-regulated vehicle parts, administers the VIN system, develops the anthropomorphic dummies used in safety testing, as well as the test protocols themselves, and provides vehicle insurance cost information.

To this end, NHTSA has a legislative mandate under Title 49 of the United States Code, Chapter 301, Motor Vehicle Safety, to issue Federal Motor Vehicle Safety Standards (FMVSS) and regulations to which manufacturers of motor vehicles and items of motor vehicle equipment must conform and certify compliance. These Federal safety standards are regulations written in terms of minimum safety performance requirements for motor vehicles or items of motor vehicle equipment. These requirements are specified in such a manner that the public is protected against unreasonable risk of crashes occurring as a result of the design, construction, or performance of motor vehicles and is also protected against unreasonable risk of death or injury in the event crashes do occur.

One such safety standard is FMVSS 201 entitled “Occupant Protection in Interior Impact,” which is incorporated herein by reference. As the title suggests, this standard specifies requirements to afford impact protection for occupants. FMVSS 201 sets forth minimum requirements for instrument panels, seat backs, interior compartment doors, sun visors and armrests. It applies to passenger cars and to multipurpose passenger vehicles, trucks and buses with a gross vehicle weight rating (GVWR) of 10,000 pounds or less.

FMVSS 201's impact protection requirements for instrument panels and seat backs involve a 15 pound, 6.5 inch diameter head form striking a point within a “head impact area” at a relative velocity of 15 miles per hour (12 mph for vehicles that meet certain occupant crash protection requirements by means of inflatable restrain systems and seat belt assemblies). FMVSS compliance testing includes a head impact location fixture that is placed in each designated seating position (DSP) to determine areas of possible head impact for each position, wherein the fixture has a pivoted arm with the head form attached to determine points of contact as the arm is swung forward. In that regard, the head impact area can include all nonglazed surfaces of the interior of a vehicle that are statically contactable by the head form of a measuring device having a pivot point to “top-of-head” dimension infinitely adjustable from 29 to 33 inches in accordance with certain defined procedures for determining the head impact area. One such head impact area includes portions of the dashboard above or surrounding a centrally located stereo head unit.

Test data for determining compliance is recorded for a number of items, e.g., impact velocity, rebound velocity, head form displacement, acceleration-time history of the head form, and the like. Also, the post impact condition of the samples and any unusual conditions are noted. For example, FMVSS 201 compliance requires that the post impact condition of the instrument panel be void of a “non-blunt” contactable edge. A non-blunt contactable edge is any pointed or sharp edge exposed in the head impact area that presents a risk, particularly during subsequent impacts, of an occupant's head striking the sharp surface.

Typical instrument panels include many objects that could potentially produce a non-blunt contactable edge condition. Thus, automobile manufacturers expend significant resources to prevent this occurrence. For example, conventional instrument panels can include a stereo head unit, climate control unit, or the like, located in the center of the dashboard, which, as previously described, may be within or adjacent to the head impact area. In order to cover gaps between the instrument panel and these electronic units, a center bezel may be employed. A bezel is a plastic trim piece that, in addition to acting as a cover, can also improve the instrument panel's aesthetic appeal by providing a clean finish between the various components installed in the instrument panel.

The center bezel attaches to the instrument panel covering the gaps around the stereo and HVAC controls. The center bezel is typically secured to the instrument panel with multiple metal clips or some other retention device extending from the rear of the bezel. Each retention clip extends into corresponding apertures formed in the instrument panel to secure the bezel to the instrument panel. The metal retention clips have a spring-like characteristic allowing them to expand and contract. The metal clips are typically biased in their expanded shape. When securing the bezel to the instrument panel, the metal clips are forced to contract by their corresponding apertures in order to squeeze the clips through the apertures as the bezel is pressed into the instrument panel. Once the clips are fully inserted into the apertures, they expand again snapping the bezel into place allowing the bezel to be a stationary trim piece.

In order for automobile manufacturers to be FMVSS 201 compliant, the center bezel should remain sufficiently secured to the instrument panel in the event of an impact. Otherwise, the potential for a non-blunt contactable edge condition to occur is likely as the outer periphery of the bezel is relatively sharp or pointed and may become exposed to potential contact from a head form directly. In order to remain sufficiently secure to the instrument panel to prevent a dangerous non-blunt contactable edge condition, it is necessary to prevent the metal retention clips from dislodging. Moreover, it is possible for a non-blunt contactable edge condition to occur when only some of the retention clips dislodge, even if only partially. Accordingly, it is necessary to prevent the bezel from coming loose during simulated impacts to prevent the exposure of a non-blunt contactable edge in non-simulated, real-life collisions. At the very least, it is necessary to prevent the exposure of a non-blunt contactable edge should the bezel dislodge only partially.

In that regard, significant expenses can be incurred in order to sufficiently secure the bezel in such a way so as to prevent any non-blunt contactable edge conditions from occurring. Conventionally, sufficiently securing the bezel often involved tweaking the instrument panel apertures that receive the retention clips to facilitate a tighter fit. Additionally or alternatively, automobile manufacturers may decide to switch to a stronger, more aggressive metal retention clip. The result is increased tool modification costs and secondary costs to modify for unique clips. Moreover, more aggressive clips having a higher retention value cost more and increase part damage when removing the bezel. Moreover, if such adjustments were made on the fly in order to comply with FMVSS 201, laboratory time and testing costs in order to obtain proper certification can increase at an alarming rate.

Thus, there exists a need for a bezel retention device that reliably prevents dangerous non-blunt contactable edge conditions from resulting during simulated impacts. This translates into an interior compartment safer from both initial and subsequent impact hazards in real-life situations. Such a device would minimize or eliminate the expensive iterative process of testing for FMVSS 201 compliance. Moreover, the device can permit the use of standard retention clips instead of adding higher retention slips, as well as avoid modifications to the instrument panel apertures. Such a bezel retention device would include one or more plastic retention tabs integrally molded into the bezel and having an array of limiting features, each of which adds to the function of securing the bezel in place.

Referring now to the drawings, FIG. 1 is a simplified, exemplary environmental diagram showing an instrument panel 12 located in an interior cabin 14 of a vehicle 10. Instrument panel 12 includes several trim components including a center bezel 16. As seen therein, center bezel 16 can be placed around the stereo head unit and/or HVAC controls located in the center of a vehicle dashboard 18. Center bezel 16 can be secured to instrument panel 12 to cover gaps between the stereo and HVAC controls of the instrument panel 12 and provide an aesthetically appealing fit and finish to the interior trim.

Center bezel 16 may be generally rectangular, but ultimately is shaped to conform to the design of instrument panel 12 and the electronic units it borders. As shown, center bezel 16 includes a top edge 20, a bottom edge 22, and left and right edges 24, each flush with instrument panel 12 or recessed within. However, were center bezel 16 to dislodge partially or completely from instrument panel 12 during an impact, one or more of the bezel edges could yield a non-blunt contactable edge condition if directed toward an occupant at a hazardous angle. Noticeably, center bezel 16 may be located within a head impact area 26 as defined in FMVSS 201. In that regard, center bezel 16 could pose a significant risk during interior impacts were it to detach from instrument panel 12. According to an embodiment of the present application, this risk is greatly minimized.

Referring now to FIG. 2, a simplified, exemplary side view of a trim component 27 having a bezel 16 according to an embodiment of the present application is shown. As seen therein, center bezel 16 can include a front surface 28 and a rear surface 30. Front surface 28 corresponds to the exposed surface of center bezel 16 facing interior cabin 14 when attached to instrument panel 12. Accordingly, front surface 28 may include aesthetic design elements to enhance the instrument panel's appearance. For example, front surface 28 of center bezel 16 may include progressive edges that are gradually rounded away from the cabin interior giving center bezel 16 a relatively “soft” finish. Despite the progressive edges, there may come a point at which front surface 28 of center bezel 16 meets rear surface 30 at center bezel's outer peripheral edge 32. The juncture between front surface 28 and rear surface 30 at outer periphery 32 may produce a relatively sharp edge. This sharp edge may not pose a hazard when center bezel 16 is secured to the instrument panel 12 as outer peripheral edge 32 may be flush against instrument panel 12 or slightly recessed therein. However, without proper securement to instrument panel 12 there is a risk that outer peripheral edge 32 may become a non-blunt contactable edge if center bezel 16 pops loose, thereby exposing outer peripheral edge 32 at an angle such that it can be struck by a human head.

To this end, trim component 27 may include a plurality of metal retention clips 34 pressed onto posts 36 extending rearward from rear surface 30 of center bezel 16 along an insertion axis 37. Metal retention clips 34 can be spring-biased in an expanded state to facilitate attachment to instrument panel 12 via corresponding apertures (not shown). The posts 36 can also facilitate locating center bezel 16 in the proper orientation and alignment. Metal retention clips 34 may compress as they are pushed through the apertures generally along the insertion axis 37 and expand again once they clear the instrument panel substrate to help secure center bezel 16 in place.

In addition to, or in place of, metal retention clips 34, trim component 27 may include one or more retention tabs 38 also extending from the rear surface 30 of center bezel 16. Retention tabs 38 may be located proximate top edge 20 of center bezel 16 and may be integrally molded therewith. It should be understood, however, that retention tabs 38 may also be separately attached to center bezel 16 in any suitable manner known to one of ordinary skill in the art. Moreover, retention tabs 38 may be positioned at alternate locations of rear surface 30 of center bezel 16 to facilitate retention without departing from the scope of the present application. In accordance with one or more embodiments, retention tabs 38 may extend from rear surface 30 of center bezel 16 at an angle generally orthogonal to center bezel's vertical face to facilitate optimum retention characteristics. Similar to metal retention clips 34, retention tabs 38 are likewise provided for insertion into corresponding apertures or slots 40 (as shown in FIG. 6) in instrument panel 12.

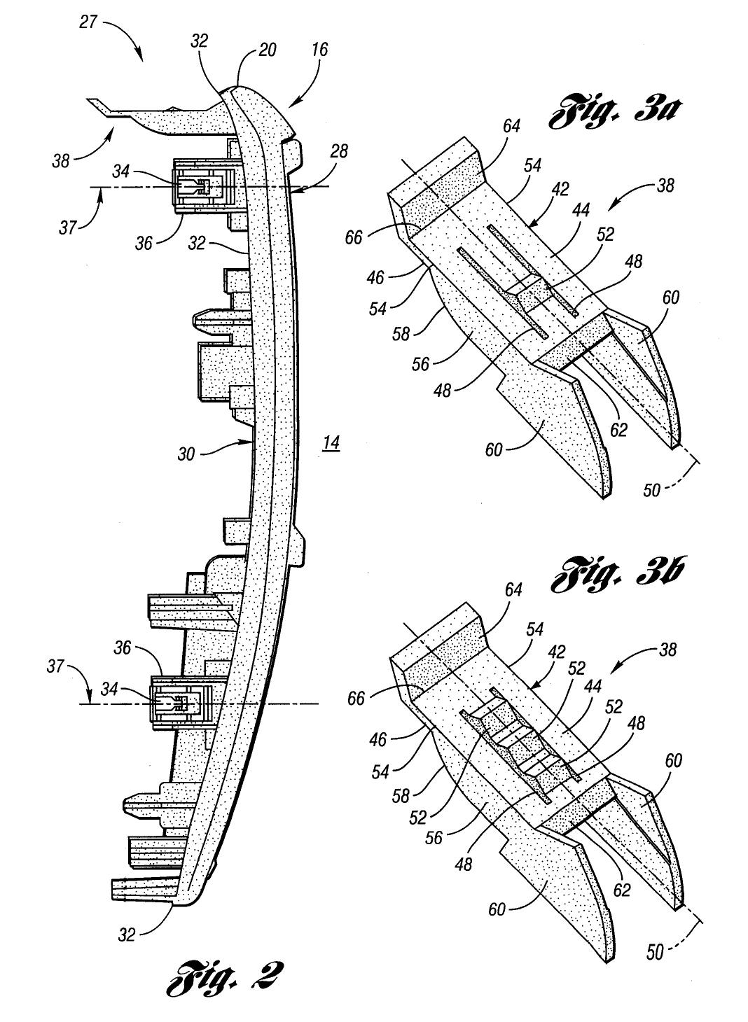

Referring now to FIGS. 3a and 3b, a simplified, exemplary perspective view of a retention tab 38 according to an embodiment of the present application is provided. As seen therein, retention tab 38 can include a main body portion 42 having a top surface 44 and a bottom surface 46. Main body portion 42 may be generally rectangular and include a pair of parallel slits 48 along a longitudinal axis 50. The longitudinal axis 50 generally defines the direction of insertion of retention tabs 38 into the corresponding slots 40 in instrument panel 12. According to one or more embodiments, the longitudinal axis 50 of retention tabs 38 may be generally parallel to the insertion axis 37 of the posts 36. Located between the pair of slits 48 on top surface 44 of retention tab 38 may be at least one nub or bump 52. The at least one nub 52 may be a generally triangular or prism-shaped protuberance which forms a part of the retention features of retention tab 38 as will be described in detail below. FIG. 3a illustrates an embodiment having only one nub 52. However, it is contemplated that more than one nub 52 may be employed without departing from the scope of the present invention, as exemplified in FIG. 3b.

Main body portion 42 can include opposing lateral edges 54. Extending downward from bottom surface 46 may be a pair of ribs 56, one each located proximate a lateral edge 54. Ribs 56 can provide structural support or rigidity to retention tab 38 minimizing flex of the retention tab 38 upon an impact as will be described in further detail below. Ribs 56 may include a generally rounded leading edge 58 that can aid in the insertion of retention tab 38 into instrument panel 12. Additionally, rounded leading edge 58 can provide for a uniform deceleration of bezel 16 during extraction from instrument panel 12, whereas a chamferred leading edge, for example, cannot. Retention tab 38 may further include a pair of legs 60 extending from a rearward edge 62 of main body portion 42 and joined with corresponding ribs 56. Legs 60 can join retention tab 38 to center bezel 16. As described earlier, legs 60 can be molded into the rear surface 30 of center bezel 16 forming retention tabs 38 integrally therewith. Alternately, legs 60 may include connecting features (not shown) that allow retention tabs 38 to be separately secured to center bezel 16.

A stop 64 may extend at a forward edge 66 of main body portion 42. Stop 64 may be angled slightly upward from main body portion 42 forming an included angle with top surface 44 between 90 and 180 degrees. Accordingly, stop 64 may provide a hook-like structure forming another part of the retention features of retention tab 38.

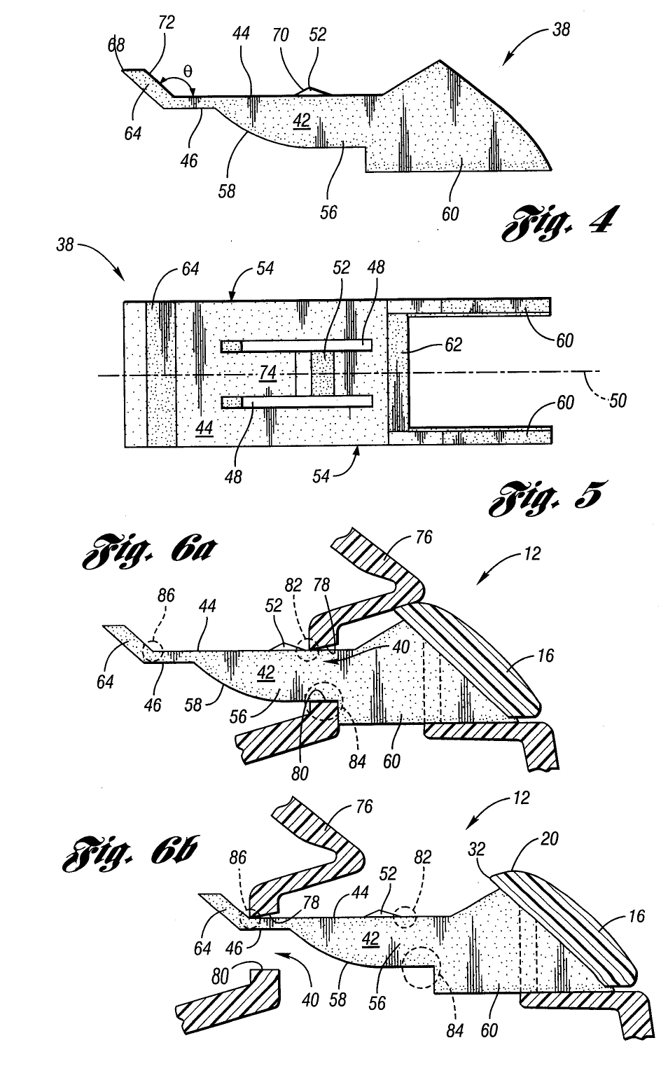

With reference now to FIG. 4, a simplified, exemplary side view of retention tab 38 according to an embodiment of the present application is shown. A profile of retention tab 38 is provided showing shape details of nub 52, ribs 56, and stop 64, in particular. As seen therein, stop 64 can include a lead-in corner 68 for easing insertion of retention 38 tab into instrument panel 12. Likewise, the at least one nub 52 may also include a slanted forward surface 70 permitting retention tab 38 to be inserted into instrument panel 12 without unnecessary struggle. Accordingly, the at least one nub 52 may be generally triangularly shaped as shown in the side profile.

As previously described, top surface 44 of main body portion 42 may form an angle θ with a retaining surface 72 of stop 64. The angle shown in FIG. 4 is exemplary only. To this end, stop 64 may be tilted to form different angles with main body portion 42. For example, top surface 44 and retaining surface 72 may form an included angle θ greater than 90° and less than 180°.

With reference now to FIG. 5, a simplified, exemplary top plan view of retention tab 38 according to an embodiment of the present application is shown. As seen therein, each slit 48 may provide a straight, narrow opening extending all the way through main body portion 42 from top surface 44 to bottom surface 46. Slits 48 can provide relief in a center strip region 74 of main body portion 42 where at least one nub 52 may reside. In that regard, slits 48 can allow center strip region 74 to flex slightly during loading temporarily displacing the at least one nub 52 during insertion of retention tab 38 into instrument panel 12, similar to a leaf spring.

With reference now to FIGS. 6a and 6b, a simplified, exemplary cross-sectional view of a portion of instrument panel 12 and center bezel 16 is provided demonstrating retention features of retention tabs 38 according to an embodiment of the present application. As seen therein, instrument panel 12 may include a base panel or substrate 76 having slot 40 for receiving each retention tab 38. Slot 40 may include an upper leading ledge 78 that can facilitate insertion of retention tab 38 into instrument panel 12, while also increasing the force required to dislodge retention tab 38 once it is inserted. Slot 40 may likewise include a lower ledge 80 generally opposing upper leading ledge 78 and defining the slot height. As shown, upper ledge 78 and lower ledge 80 of slot 40 can apply exposing forces on main body portion 42 of retention tab 38 helping to hold it in place during normal circumstances. However, during an impact, center bezel 16 may have a tendency to want separate from instrument panel 12 with forces that exceed the pressure applied by slot 40 pressed against the main body portion 42 of retention tab 38.

Accordingly, a plurality of limiting features may be provided. For example, a first limiting feature 82 located at the base of the at least one nub 52 can help retain center bezel 16 from dislodging from instrument panel 12 during an impact. In that regard, first limiting feature 82 can be designed to prevent retention 38 tab from sliding outward through slot 40 over the at least one nub 52. Should the force at impact be sufficient to overcome the first limiting feature 82 provided by the at least one nub 52, the at least one nub 52 can operate to at least reduce the force acting to dislodge center bezel 16. To this end, the at least one nub 52 may also act as a sort of “speed bump” at least slowing the retention tab 38 through slot 40 during an impact, if not entirely stopping it.

A second limiting feature 84 may also be provided where ribs 56 engage lower ledge 80 of slot 40. As previously described, ribs 56 can provide structural support and rigidity to retention tab 38 preventing it from flexing during an impact. Accordingly, ribs 56 can act against lower ledge 80 of slot 40 precluding retention tab 38 from flexing downward as the impact forces attempts to urge retention tab 38 out of slot 40. In that regard, the first limiting feature 82 provided by the at least one nub 52 can be more effective. Thus, ribs 56 and lower ledge 80 can work together and in conjunction with the first limiting feature 82 to minimize the tendency of retention tab 38 to dislodge from instrument panel substrate 76.

A third limiting feature 86 is also depicted in FIGS. 6a and 6b. As shown, third limiting feature 86 can be provided by stop 64. Stop 64 can form a hook-end on retention tab 38 operable to catch against upper ledge 78 of slot 40 in the event center bezel 16 becomes partially dislodged from instrument panel 12. The third limiting feature 86 can work to snag center bezel 16 preventing it from dislodging entirely and creating a hazardous non-blunt contactable edge condition. It is noted that the combination of the first limiting feature 82 and the second limiting feature 84 can work to at least slow the rate of disengagement of center bezel 16 from instrument panel 12 permitting the third retention feature 86 formed by stop 64 to prevent complete dislodgement of center bezel 16. As shown in FIG. 6b, by the third limiting feature 86 catching against upper ledge 78 of slot 40, outer peripheral edge 32 of center bezel 16 remains oriented such that a non-blunt contactable edge condition can be prevented.

The combination of the first, second and third limiting features of retention tab 38 can work in combination to reliably retain center bezel 16 in engagement with instrument panel 12 during impacts minimizing the occurrence of non-blunt contactable edge conditions than can be generated by center bezel 16, if not eliminating the occurrence completely. Such retention tabs can reduce costs associated with FMVSS 201 compliance testing as well. In that regard, retention tabs 38 allow center bezel 16 to meet safety standards without having to make expensive, iterative changes, such as modifying slots or switching to more aggressive retention clips 34.

While various embodiments have been illustrated and described, it is not intended that these embodiments illustrate and describe all possible forms of the invention. Rather, the words used in the specification are words of description rather than limitation, and it is understood that various changes may be made without departing from the spirit and scope of the application.

What is claimed is:

1. A retention tab comprising:
a main body portion having a top surface, a bottom surface, a forward edge, a rearward edge, and two opposing lateral edges defining a longitudinal axis of the retention tab that generally bisects the forward edge and rearward edge;
at least one nub protruding from the top surface of the main body portion;
a pair of spaced-apart ribs generally parallel to one another extending from the bottom surface of the main body portion at angle generally transverse to the bottom surface, each rib disposed along at least a portion of one of the two opposing lateral edges and including a rounded leading edge nearest the forward edge of the main body portion;
a stop extending from the forward edge of the main body portion, the stop including a retaining surface forming an included obtuse angle with the top surface of the main body portion; and
at least one connecting leg formed proximate the rearward edge of the main body portion for connecting the retention tab to a piece of interior trim.

2. The retention tab of claim 1, wherein the at least one nub is prism shaped.

3. The retention tab of claim 2, wherein the at least one nub includes a slanted forward surface generally facing towards the forward edge of the main body portion, the slanted forward surface intersecting the top surface of the main body portion to form an obtuse angle.

4. The retention tab of claim 3, wherein the at least one nub comprises a plurality of nubs arranged linearly along the longitudinal axis of the retention tab.

5. The retention tab of claim 4, wherein the plurality of nubs are spaced apart from one another.

6. The retention tab of claim 4, wherein the plurality of nubs abut one another.

7. The retention tab of claim 4, wherein the plurality of nubs comprises three nubs.

8. The retention tab of claim 1, further comprising a pair of parallel slits formed within the main body portion along the longitudinal axis, one of the pair of slits formed on either side of the at least one nub defining a center strip region whereupon the at least one nub is disposed.

9. The retention tab of claim 8, wherein the center strip region forms a leaf spring that can deflect and return to its original position.

10. The retention tab of claim 1, wherein the at least one connecting leg comprises a pair of connecting legs corresponding to the pair of ribs, each connecting leg extending from a corresponding rib beyond the rearward edge of the main body portion.

11. A trim component for attachment to a trim panel, the trim component comprising:
a bezel having a front surface, a rear surface and an outer peripheral edge;
one or more posts for locating and attaching the bezel to the trim panel, the one or more posts extending from the rear surface of the bezel along an insertion axis; and
one or more retention tabs extending outward away from the rear surface of the bezel adjacent the outer peripheral edge, the one or more retention tabs including:
a main body portion having a top surface, a bottom surface, a forward edge farthest from the rear surface of the bezel, a rearward edge nearest the rear surface, and two opposing lateral edges defining a longitudinal axis of the retention tab that generally bisects the forward edge and rearward edge, the longitudinal axis being generally parallel to the insertion axis of the one or more posts;
at least one nub protruding from the top surface of the main body portion;
a pair of spaced-apart ribs generally parallel to one another extending from the bottom surface of the main body portion at angle generally transverse to the bottom surface, each rib disposed along at least a portion of one of the two opposing lateral edges and including a rounded leading edge nearest the forward edge of the main body portion;
a stop extending from the forward edge of the main body portion, the stop including a retaining surface forming an included obtuse angle with the top surface of the main body portion; and
at least one connecting leg extending from the rearward edge of the main body portion for joining the retention tab to the rear surface of the bezel.

12. The bezel of claim 11, wherein the at least one nub is prism shaped.

13. The retention tab of claim 12, wherein the at least one nub includes a slanted forward surface generally facing away from the bezel, the slanted forward surface intersecting the top surface of the main body portion to form an obtuse angle.

14. The retention tab of claim 13, wherein the at least one nub comprises a plurality of nubs arranged linearly along the longitudinal axis of the retention tab.

15. The retention tab of claim 14, wherein the plurality of nubs are spaced apart from one another.

16. The retention tab of claim 14, wherein the plurality of nubs abut one another.

17. The retention tab of claim 14, wherein the plurality of nubs comprises three nubs.

18. The retention tab of claim 11, further comprising a pair of parallel slits formed within the main body portion along the longitudinal axis, one of the pair of slits formed on either side of the at least one nub defining a center strip region whereupon the at least one nub is disposed.

19. The retention tab of claim 18, wherein the center strip region forms a leaf spring that can deflect and return to its original position.

20. A trim component for attachment to a trim panel, the trim component comprising:
a bezel having a front surface, a rear surface and an outer peripheral edge;
one or more posts for locating and attaching the bezel to the trim panel, the one or more posts extending from the rear surface of the bezel along an insertion axis, the one or more posts including spring-biased retention clips attached thereto; and
one or more integrally formed retention tabs extending outward away from the rear surface of the bezel adjacent the outer peripheral edge, the one or more retention tabs including:
a main body portion having a top surface, a bottom surface, a forward edge farthest from the rear surface of the bezel, a rearward edge nearest the rear surface, and two opposing lateral edges defining a longitudinal axis of the retention tab that generally bisects the forward edge and rearward edge, the longitudinal axis being generally parallel to the insertion axis of the one or more posts;
a pair of parallel slits formed within the main body portion along the longitudinal axis, the pair of parallel slits defining a flexible center strip region in the main body portion;
at least one prism-shaped nub protruding from the top surface of the main body portion in the center strip region, the at least one nub including a slanted forward surface generally facing away from the bezel, the slanted forward surface intersecting the top surface of the main body portion to form an obtuse angle;
a pair of spaced-apart ribs generally parallel to one another extending from the bottom surface of the main body portion at angle generally transverse to the bottom surface, each rib disposed along at least a portion of one of the two opposing lateral edges;
a stop extending from the forward edge of the main body portion, the stop including a retaining surface forming an included obtuse angle with the top surface of the main body portion; and
a pair of legs extending from the rearward edge of the main body portion for joining the retention tab to the rear surface of the bezel, each connecting leg extending from a corresponding rib beyond the rearward edge of the main body portion.
